(19) United States
(12) Patent Application Publication
(10) Pub. No.: US 2010/0289928 A1
(43) Pub. Date: Nov. 18, 2010

(54) Video Signal Processing Unit and Display Unit

(76) Inventor: Tomoya YANO, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/766,524

(22) Filed: Apr. 23, 2010

(30) Foreign Application Priority Data
May 14, 2009 (JP) P2009-117838

(51) Int. Cl. H04N 5/217; H04N 5/14

(52) U.S. Cl. 348/241; 348/571; 348/E05.078; 348/E05.062

(57) ABSTRACT

The video signal processing unit includes: a detecting section detecting, in each predetermined unit period, a characteristic value from an input video signal, the input video signal being obtained by an image pick-up operation with an image pick-up device, the characteristic value showing a characteristic of an image pick-up blur occurring in the image pick-up operation; and a correcting section making a sequential correction, in the each unit period, for every pixel value of an input video image with use of the characteristic value, thereby suppressing the image pick-up blur to generate an output video signal free from the image pick-up blur. The correcting section makes a correction to a target pixel value in the input video image within a current unit period by utilizing a correction result in a corrected pixel in the input video image within the current unit period.

### BACKGROUND OF THE INVENTION

1. Field of the Invention

The present invention relates to a video signal processing unit for performing processing of improving an image quality including an image pick-up blur contained in a video signal, and a display unit including such a video signal processing unit.

2. Description of the Related Art

In recent years, in video signal processing unites for displaying video images (motion images), it has been proposed a display technique free from video quality degradation even in the case where there is no constant synchronous relationship of a frame frequency or a field frequency between an input side television system and an output side television system. More specifically, a technique of adjusting a frame rate (a frame rate conversion technique) has been proposed (for example, see Japanese Unexamined Patent Application Publication No. 2006-66987).

However, when the frame rate is increased using the existing frame rate conversion techniques such as that in JP2006-66987A, a motion blur (an image pick-up blur) occurring at the time of image capturing (image pick-up operation) has not been considered. Therefore, an image including the image pick-up blur (a blurred image) has not been improved particularly and remained as it is, leading to a problem that it is difficult to display a sharp image on a display unit.

With the foregoing in mind, Japanese Unexamined Patent Application Publication No. 2006-81150, for example, has proposed a technology for improving such a problem.

### SUMMARY OF THE INVENTION

The video signal processing unit according to JP2006-81150A includes a filtering means that applies a low-pass filter (LPF) whose characteristic is converted by a filter characteristic conversion means to output a resultant corrected pixel value of a target pixel as a first value. Also, a subtraction means is provided that computes the difference between a pixel value of the target pixel before being corrected and the first value outputted from the filtering means to output the resultant difference value as a second value. Further, an addition means is provided that adds the second value outputted from the subtraction means to the pixel value of the target pixel before being corrected to output a resultant addition value as the pixel value of the target pixel after being corrected.

In other words, since the technique of JP2006-81150A adopts a structure of a so-called FIR (Finite Impulse Response) filter by the number of taps of a moving amount width, it has not been sufficient as a filter for remedying the image pick-up blur. In particular, when the moving amount is used as a sampling frequency, an effect on a spatial frequency that is, for example, ½ or higher than the sampling frequency has been insufficient, and there is room for improvement.

In view of the foregoing, it is desirable to provide a video signal processing unit and a display unit capable of improving the image quality including the image pick-up blur in a more appropriate manner.

According to an embodiment of the present invention, there is provided a video signal processing unit, including: a detecting section detecting, in each unit period, a characteristic value from an input video signal obtained by an image pick-up operation with an image pick-up device, the characteristic value showing a characteristic of image pick-up blur occurring in the image pick-up operation; and a correcting section making a sequential correction, in each unit period, for pixel values of an input video image formed of the input video signal with use of the characteristic value, thereby suppressing the image pick-up blur in the input video signal, to generate an output video signal. The correcting section makes a correction to a target pixel value in the input video image within a current unit period by utilizing a correction result of a corrected pixel in the input video image within the current unit period.

According to an embodiment of the present invention, there is provided a display unit including: a detecting section detecting, in each unit period, a characteristic value from an input video signal obtained by an image pick-up operation with an image pick-up device, the characteristic value showing a characteristic of image pick-up blur occurring in the image pick-up operation; a correcting section making a sequential correction, in each unit period, for pixel values of an input video image formed of the input video signal with use of the characteristic value, thereby suppressing the image pick-up blur in the input video signal, to generate an output video signal; and a display section displaying a video image based on the output video signal. The correcting section makes a correction to a target pixel value in the input video image within a current unit period by utilizing a correction result in a corrected pixel in the input video image within the current unit period.

In the video signal processing unit and the display unit according to the embodiment of the present invention, the characteristic value showing the characteristic of the image pick-up blur occurring in the image pick-up operation is detected, in each unit period, from the input video signal, and the sequential correction is made, in the each unit period, for pixel values of the input video image formed of the input video signal with use of the characteristic value, thereby the image pick-up blur in the input video signal is suppressed, and the output video signal is generated. Further, the correction is made to the target pixel value in the input video image within the current unit period by utilizing the correction result in the corrected pixel in the input video image within the current unit period. In this way, such a correction functions as a so-called IIR (Infinite Impulse Response) filter processing in a spatial direction.

A video signal processing unit according to another embodiment of the present invention includes: the detecting section described above; and a correcting section making a sequential correction, in the each unit period, for pixel values of an input video image formed of the input video signal with use of the characteristic value, thereby suppressing the image pick-up blur in the input video signal, to generate an output video signal. The correcting section makes a correction to a target pixel value in the input video image within a current unit period by utilizing a correction result in a corrected pixel which is the same pixel that has been corrected in an input video image within an immediately-preceding unit period. In this video signal processing unit according to another embodiment of the present invention, the correction is made to the target pixel value in the input video image within the current unit period by utilizing the correction result in the corrected pixel which is the same pixel that has been corrected in the input video image within the immediately-preceding unit period. In this way, such a correction functions as the IIR filter processing in a time direction. Thus, the image pick-up blur may be suppressed also in the input video signal containing a spatial frequency component higher than that in the past, making it possible to improve the image quality including the image pick-up blur in a more appropriate manner.

With the video signal processing unit and the display unit according to the embodiment of the present invention, the correction is made to the target pixel value in the input video image within the current unit period by utilizing the correction result in the corrected pixel in the input video image within the current unit period. Thus, such a correction may function as an IIR filter processing in a spatial direction. Therefore, the image pick-up blur may be suppressed also in the input video signal containing a spatial frequency component higher than that in the past, making it possible to improve the image quality including the image pick-up blur in a more appropriate manner.

### BRIEF DESCRIPTION OF THE DRAWINGS

FIG. 1 is a block diagram showing the whole structure of a display unit according to a first embodiment of the present invention.

FIG. 2 is a block diagram showing the detailed structure of an image pick-up blur suppressing section shown in FIG. 1.

FIG. 3 is a block diagram showing the detailed structure of an estimated value generating section shown in FIG. 2.

FIG. 4 is a block diagram showing the detailed structure of a corrected value calculating section shown in FIG. 2.

FIG. 5 shows characteristics of an exemplary relationship between an update coefficient and a frame number.

FIG. 6 is a block diagram showing the detailed structure of a corrected value delay section shown in FIG. 2.

FIG. 7 is a block diagram showing the detailed structure of an image pick-up blur suppressing section according to a modification of the first embodiment (modification 1).

FIG. 8 is a waveform diagram showing an exemplary phase relationship between image pick-up blurs and estimated values in a step image according to modification 1.

FIG. 9 shows characteristics of an exemplary mixing ratio of corrected values (estimated values) according to modification 1.

FIG. 10 is a block diagram showing the detailed structure of an image pick-up blur suppressing section according to another modification of the first embodiment (modification 2).

FIG. 11 is a block diagram showing the detailed structure of an estimated value generating section shown in FIG. 10.

FIG. 12 is a block diagram showing the detailed structure of a corrected value calculating section shown in FIG. 10.

FIG. 13 shows characteristics of an exemplary mixing ratio of pieces of trust information according to modification 2.

FIG. 14 is a block diagram showing the detailed structure of an image pick-up blur suppressing section according to a second embodiment of the present invention.

FIG. 15 is a block diagram showing the detailed structure of an estimated value generating section shown in FIG. 14.

FIG. 16 is a block diagram showing the detailed structure of a corrected value calculating section shown in FIG. 14.

FIG. 17 is a block diagram showing the detailed structure of a corrected value delay section shown in FIG. 14.

FIG. 18 is a block diagram showing the detailed structure of an image pick-up blur suppressing section according to a modification of the second embodiment (modification 3).

FIG. 19 is a waveform diagram showing an exemplary phase relationship between image pick-up blurs and estimated values in a step image according to modification 3.

FIG. 20 is a block diagram showing the detailed structure of one estimated value generating section shown in FIG. 18.

FIG. 21 is a block diagram showing the detailed structure of the other estimated value generating section shown in FIG. 18.

FIG. 22 is a block diagram showing the detailed structure of a corrected value calculating section shown in FIG. 18.

FIG. 23 shows characteristics of an exemplary mixing ratio of corrected values (estimated values) according to modification 3.

FIG. 24 shows characteristics of an exemplary mixing ratio of pieces of trust information according to modification 3.

FIG. 25 is a block diagram showing the detailed structure of a corrected value phase converting section shown in FIG. 18.

FIG. 26 is a block diagram showing the detailed structure of an image pick-up blur suppressing section according to another modification of the second embodiment (modification 4).

FIG. 27 is a block diagram showing the detailed structure of a high frame rate converting section shown in FIG. 26.

FIG. 28 is a block diagram showing the detailed structure of an image pick-up blur suppressing section according to another modification of the second embodiment (modification 5).

FIG. 29 is a block diagram showing the detailed structure of a corrected value calculating IP converting section shown in FIG. 28.

FIG. 30 is a block diagram showing an exemplary hardware structure of the whole or part of a video signal processing unit to which the embodiment of the present invention is applied.

### DETAILED DESCRIPTION OF THE PREFERRED EMBODIMENTS

Preferred embodiments of the present invention will be described in detail below referring to the accompanying drawings. The description will follow the order below.
1. First embodiment (Example of an image pick-up blur suppression by a processing within a frame)

Modification 1 (Example of the case of mixing corrected values calculated in two directions within a frame)

Modification 2 (Example of the case of calculating a corrected value using a plurality of estimated values)
2. Second embodiment (Example of an image pick-up blur suppression by a processing between frames)

Modification 3 (Example of the case of calculating a corrected value using estimated values from foregoing and following frames)

Modification 4 (Example of the case of being integrated with a high frame rate conversion)

Modification 5 (Example of the case of being integrated with an IP converting section)

### 1. First Embodiment

### [Whole Structure of Display Unit 1]

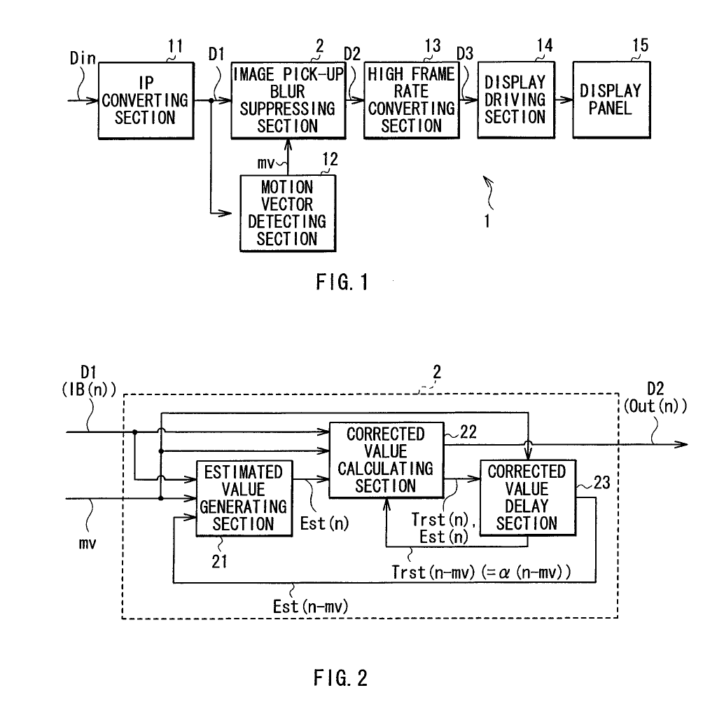

FIG. 1 shows a block structure of a display unit 1 according to a first embodiment of the present invention. This display unit 1 includes an IP (Interlace Progressive) converting section 11, a motion vector detecting section 12 (a detecting section), an image pick-up blur suppressing section 2 (a correcting section), a high frame rate converting section 13, a display driving section 14, and a display panel 15. The motion vector detecting section 12 and the image pick-up blur suppressing section 2 correspond to an illustrative example of the “video signal processing unit” of the embodiment of the present invention.

The IP converting section 11 subjects an input video signal Din (an interlace signal) obtained by an image pick-up operation in an image pick-up device (not shown) to an IP conversion, thereby generating a video signal D1 configured of a progressive signal.

The motion vector detecting section 12 detects a characteristic value showing characteristics of an image pick-up blur occurring at the time of the above-mentioned image pick-up operation by each frame period (unit period) in the video signal D1 outputted from the IP converting section 11. As an example of such a characteristic value, a motion vector mv is used in the present embodiment.

In the following, the value of the motion vector mv is referred to as a moving speed (a moving amount), and the direction of the motion vector mv is referred to as a moving direction. This moving direction may be any direction in a two dimensional plane. In the display unit 1, various processings, which will be described later, may be executed in the same manner whichever direction in the two dimensional plane the moving direction may be.

The image pick-up blur suppressing section 2 corrects every pixel value in the input video image configured of the video signal D1 by each frame period using the motion vector mv detected in the motion vector detecting section 12, thereby suppressing the image pick-up blur contained in this video signal D1. In this way, a video signal D2 after such a correction (after image pick-up blur suppression) is generated. More specifically, the image pick-up blur suppressing section 2 makes a sequential correction to every pixel value in each frame period and, at the time of the correction in a target pixel, makes the correction by utilizing a correction result in the pixel that has been corrected in the input video image within the current frame period. The detailed structure and the detailed operation of this image pick-up blur suppressing section 2 will be described later.

The high frame rate converting section 13 subjects the video signal D2 outputted from the image pick-up blur suppressing section 2 to a high frame rate conversion, and generates and outputs a video signal D3. More specifically, the high frame rate converting section 13 subjects the video signal D2 having a first frame rate to a high frame rate conversion, and outputs the video signal D3 having a second frame rate that is higher than the first frame rate to the display driving section 14. This high frame rate conversion is a processing that is executed when the first frame rate at the time of input is lower than the second frame rate at the time of output (display). More specifically, a new frame is generated and inserted between individual frames configuring a motion image at the time of input, thereby converting the first frame rate into the higher second frame rate.

It should be noted that the first frame rate refers to a frame rate of a motion image at the time of input to the high frame rate converting section 13. Thus, the first frame rate may be any frame rate. Here, the first frame rate is a frame rate when the image pick-up device, which is not shown, captures the motion image, that is, an image pick-up frame rate, for example.

The display driving section 14 carries out a display driving operation with respect to the display panel 15 based on the video signal D3 outputted from the high frame rate converting section 13.

The display panel 15 displays a video image based on the video signal D3 in accordance with the display driving operation of the display driving section 14. This display panel 15 may be, for example, various displays such as LCDs (Liquid Crystal Displays), PDPs (Plasma Display Panels), and organic EL (Electro Luminescence) displays.

### [Detailed Structure of Image Pick-Up Blur Suppressing Section 2]

Next, the image pick-up blur suppressing section 2 will be detailed with reference to FIG. 2 to FIG. 6. FIG. 2 shows the detailed structure of the image pick-up blur suppressing section 2. The image pick-up blur suppressing section 2 has an estimated value generating section 21, a corrected value calculating section 22, and a corrected value delay section 23.

### (Estimated Value Generating Section 21)

The estimated value generating section 21 calculates an estimated value Est(n) of a corrected value (i.e., a corrected pixel value) in a target pixel “n” based on the motion vector mv, the video signal D1 (pixel data IB(n), which will be described later; with “n” indicating the target pixel), and an estimated value Est(n−mv) outputted from the corrected value delay section 23, which will be described later.

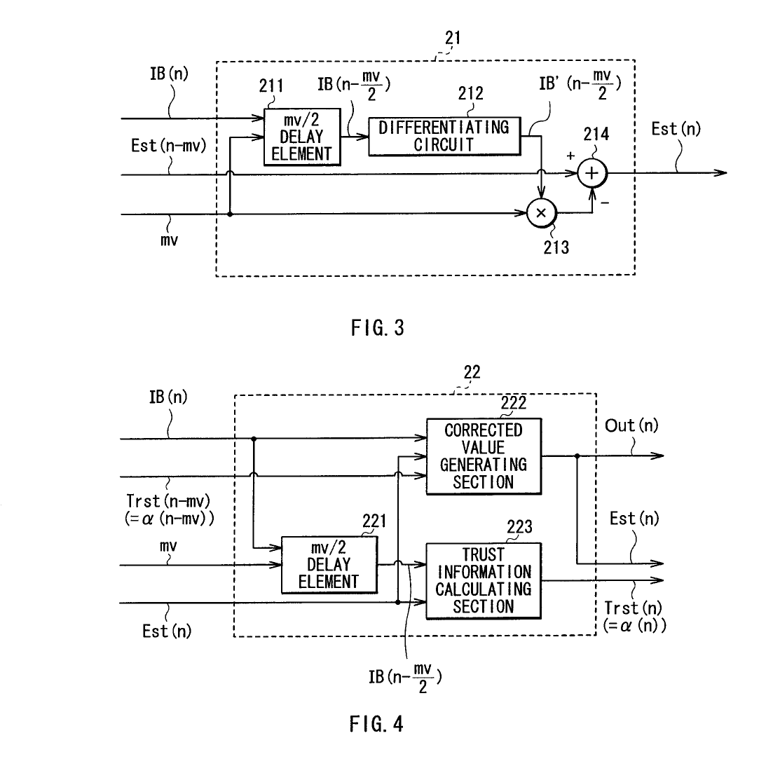

FIG. 3 shows the detailed structure of this estimated value generating section 21. The estimated value generating section 21 has an mv/2 delay element 211, a differentiating circuit 212, a multiplier 213, and an adder 214.

The mv/2 delay element 211 generates image data IB(n−mv/2) corresponding to a pixel position that is delayed by a pixel corresponding to the value of mv/2, based on the image data IB(n) and the motion vector mv.

The differentiating circuit 212 performs a predetermined differential operation, which will be described in the following, based on the image data IB(n−mv/2) outputted from the mv/2 delay element 211, thereby generating a pixel differentiation value IB′(n−mv/2) in the direction of sequential correction.

First, as a model representing an image pick-up blur, a pixel position (a target pixel) in a motion image captured while a shutter is open is given as “n”, image data containing the image pick-up blur at time t0 is given as IB(n, t0), a frame period at the time of image pick-up is given as T, and an ideal value without image pick-up blur is given as Ireal(n, t). Then, the image data IB(n, t0) may be expressed by the formula (1) below. Also, when at least part of the image containing the target pixel “n” is assumed to move at a constant speed in a parallel manner, the formula (2) below may be set up. Here, mv represents a motion vector per frame. From this formula (2), by obtaining the adjacent difference in the direction of the motion vector mv, it is possible to express the pixel differentiation value IB′(n) in the direction of the motion vector mv of the image data IB(n) containing the image pick-up blur by the formula (3) below.

$$\begin{matrix}IB ( n , {t}_{0} ) = {\int }_{0 - T}^{0} Ireal ( n , t ) d t & ( 1 ) \\ IB ( n ) = \frac{{\sum }_{n + mv - 1}^{n} Ireal ( n )}{\vert mv \vert} & ( 2 ) \\ {IB}^{′} ( n ) = IB ( n + 1 ) - IB ( n ) = \frac{Ireal ( n + mv ) - Ireal ( n )}{\vert mv \vert} & ( 3 )\end{matrix}$$

The multiplier 213 multiplies the pixel differentiation value IB′(n−mv/2) outputted from the differentiating circuit 212 by the motion vector mv. The adder 214 adds a negative (−) value of the multiplied value of the multiplier 213 and an estimated value Est(n−mv) together, thereby generating an estimated value Est(n).

More specifically, these operations may be expressed by the formulae below. First, the formula (3) described above may be rewritten as the formula (4) below. Also, from this formula (4), when a pixel that is located away from the target pixel “n” by the motion vector mv is free from an image pick-up blur, an image without an image pick-up blur (an estimate of the image data; estimated value Est(n)) may be obtained by the formulae (5) and (6) below. Further, when a phase correction term is added to these formulae (5) and (6), the formulae (7) and (8) below are obtained. Incidentally, the relationship between the formulae (7) and (8) is merely a relationship obtained by interchanging the polarities of the motion vector mv. In other others, it is appropriate to perform the correction of the target pixel “n” using the estimated value at the pixel position at a distance of an absolute value of the motion vector mv without particularly considering the direction of the motion vector mv and the direction of the processing.

$$\begin{matrix}Ireal ( n ) = Ireal ( n + mv ) - {IB}^{′} ( n ) \cdot \vert mv \vert & ( 4 ) \\ [ \begin{matrix}Est ( n ) = Est ( n + mv ) - {IB}^{′} ( n ) \cdot \vert mv \vert & \\ Est ( n ) = Est ( n - mv ) + {IB}^{′} ( n - mv ) \cdot \vert mv \vert & \end{matrix} & \begin{matrix}( 5 ) \\ ( 6 )\end{matrix} \\ [ \begin{matrix}Est ( n ) = Est ( n + mv ) - {IB}^{′} ( n + \frac{mv}{2} ) \cdot \vert mv \vert \\ Est ( n ) = Est ( n - mv ) + {IB}^{′} ( n - \frac{mv}{2} ) \cdot \vert mv \vert\end{matrix} & \begin{matrix}( 7 ) \\ ( 8 )\end{matrix}\end{matrix}$$

### (Corrected Value Calculating Section 22)

The corrected value calculating section 22 calculates a corrected value based on the motion vector mv, the video signal D1 (pixel data IB(n)), the estimated value Est(n) outputted from the estimated value generating section 21, and trust information Trst(n−mv) outputted from the corrected value delay section 23, which will be described later. More specifically, the corrected value calculating section 22 outputs the trust information Trst(n) and the estimated value Est(n) to the corrected value delay section 23 and outputs a video signal D2 (output pixel data Out(n); i.e., a corrected pixel value).

FIG. 4 shows the detailed structure of the corrected value calculating section 22. The corrected value calculating section 22 has an mv/2 delay element 221, a corrected value generating section 222, and a trust information calculating section 223.

The mv/2 delay element 221 generates image data IB(n−mv/2) corresponding to a pixel position that is delayed by a pixel corresponding to the value of mv/2, based on the image data IB(n) and the motion vector mv.

The corrected value generating section 222 generates the estimated value Est(n) and the video signal D2 (output pixel data Out(n)) by using the formula (9) below, based on the image data IB(n), the estimated value Est(n), and the trust information Trst(n−mv). The operation expressed by this formula (9) has a so-called IIR filter configuration. It is noted that, in the formula (9), α indicates an update coefficient, which may be a value from 0 to 1, and the value of the update coefficient α should be changed suitably. Further, from the formula (9), it is understood that a correction level for the target pixel “n” is controlled using this update coefficient α.

The trust information calculating section 223 generates the trust information Trst(n) using the formulae (10) and (11) below, based on the image data IB(n−mv/2) outputted from the mv/2 delay element 221 and the estimated value Est(n).

More specifically, the trust information Trst(n) is obtained as follows. First, the likelihood of the estimated value Est(n) depends on the correction result at a pixel position that is located away from the target pixel “n” by the motion vector mv. Therefore, the likelihood is considered to be higher as the difference value is smaller between the correction result (corrected value) and the original pixel value containing the image pick-up blur at this pixel position at a distance of the motion vector mv. Thus, with respect to the likelihood of the estimated value Est(n), for example, when the correction amount at the pixel position at a distance of the motion vector mv is given as Δ, the trust information Trst(n) may be expressed by a function F(Δ) of this correction amount Δ and used as the update coefficient α described above. Accordingly, when the correction is carried out along the direction in which the target pixel “n” increases in number, the trust information Trst(n)(=α(n)) is expressed by the formulae (10) and (11) below. Incidentally, this function F(Δ) is expressed by a function that decreases consistently with respect to the correction amount Δ and, for example, (1−Δ).

$$\begin{matrix}Out ( n ) = ( Est ( n ) ) - IB ( n ) ) \cdot α + IB ( n ) & ( 9 ) \\ [ \begin{matrix}Δ ( n - mv ) = ( Est ( n - mv ) - IB ( n - mv ) ) & \\ Trst ( n - mv ) = F ( Δ ( n - mv ) ) & \end{matrix} & \begin{matrix}( 10 ) \\ ( 11 )\end{matrix}\end{matrix}$$

Further, when the value of the trust information Trst(n−mv) is large, the likelihood of the estimated value Est(n) as the correction result is also high. Therefore, the likelihood as high as the trust information Trst(n−mv) may be set to the trust information Trst(n). In other words, the trust information Trst(n) may be expressed by the formulae (12) and (13) below.

$$[ \begin{matrix}\begin{matrix}Trst ( n ) = Trst ( n - mv ) in the case \\ of Trst ( n - mv ) > F ( Δ ( n ) )\end{matrix} & \\ \begin{matrix}Trst ( n ) = F ( Δ ( n ) ) in the case \\ of Trst ( n - mv ) \leq F ( Δ ( n ) )\end{matrix} & \end{matrix} \qquad \begin{matrix}( 12 ) \\ ( 13 )\end{matrix}$$

Moreover, when the update coefficient α varies considerably by each frame, flicker is sometimes perceived in the motion image. Accordingly, in order to reduce this flicker, it is also possible to set two predetermined constants k1 and k2 and express the trust information Trst(n) by the formulae (14) and (15) below.

$$[ \begin{matrix}\begin{matrix}Trst ( n ) = k 1 \cdot F ( Δ ( n ) ) in the case \\ of Trst ( n - mv ) > k 1 \cdot F ( Δ ( n ) ) \end{matrix} & \\ \begin{matrix}Trst ( n ) = F ( Δ ( n ) ) \cdot k 2 + Trst ( n - mv ) \cdot ( 1 - k 2 ) in the case \\ of Trst ( n - mv ) \leq k 1 \cdot F ( Δ ( n ) )\end{matrix} & \end{matrix} \qquad \begin{matrix}( 14 ) \\ ( 15 )\end{matrix}$$

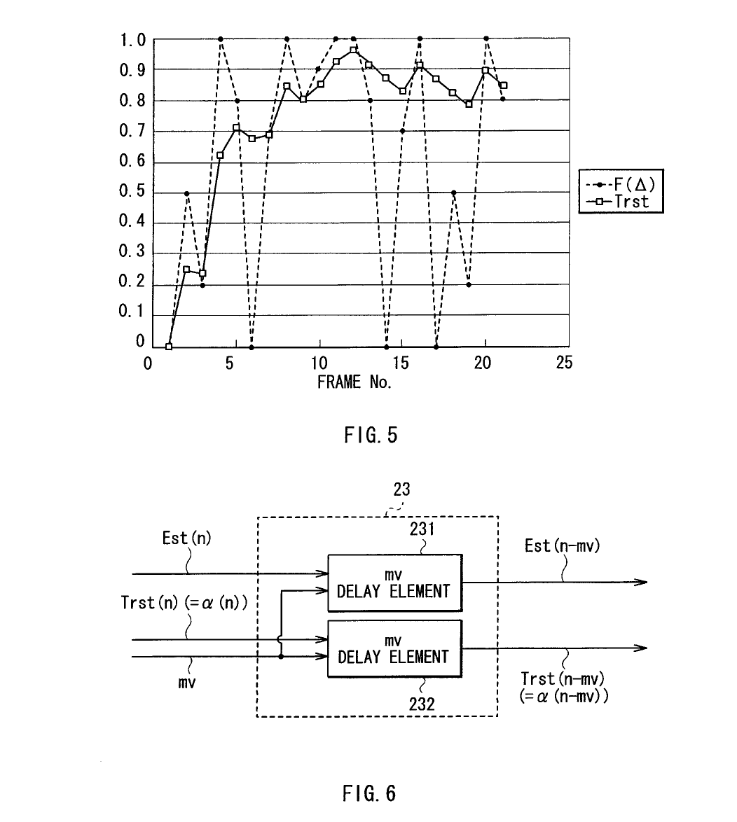

As an example, FIG. 5 shows the variation of the function F(Δ) and that of the trust information Trst(n) in the case where k1=0.95 and k2=0.50 in the formulae (14) and (15) above with respect to the frame number (No).

In addition, in an image containing noise, the trust information Trst(n) is also affected. Thus, it is also effective to perform a suitable LPF processing with neighboring pixels within the frame period. Further, there is a possibility that the correction amount Δ increases due to a noise component, so that the value of the trust information Trst(n) could be estimated to be smaller than necessary. Thus, it is also appropriate to detect the noise component and perform gain control of the value of the correction amount Δ according to the noise component.

### (Corrected Value Delay Section 23)

The corrected value delay section 23 stores (holds) the trust information Trst(n) and the estimated value Est(n) outputted from the corrected value calculating section 22, and functions as a delay element with a magnitude of the motion vector mv.

FIG. 6 shows the detailed structure of the corrected value delay section 23. The corrected value delay section 23 has two mv delay elements 231 and 232.

The mv delay element 231 generates the estimated value Est(n−mv) corresponding to a pixel position that is delayed by a pixel corresponding to the value of mv, based on the estimated value Est(n) and the motion vector mv. The mv delay element 232 generates the trust information Trst(n−mv) corresponding to a pixel position that is delayed by a pixel corresponding to the value of mv, based on the trust information Trst(n) and the motion vector mv.

### [Effects of Display Unit 1]

Now, the effects of the display unit 1 will be described.

### (Basic Operation)

In this display unit 1, as shown in FIG. 1, the IP converting section 11 first subjects an input video signal Din (an interlace signal) to an IP conversion, thereby generating a video signal D1 configured of a progressive signal. Next, the motion vector detecting section 12 detects a motion vector mv by each frame period in this video signal D1. Subsequently, the high frame rate converting section 13 subjects the video signal D2 outputted from the image pick-up blur suppressing section 2, which will be described in the following, to a high frame rate conversion, and generates a video signal D3. Then, the display driving section 14 carries out a display driving operation with respect to the display panel 15 based on this video signal D3. In this way, the display panel 15 displays a video image based on the video signal D3.

### (Image Pick-Up Blur Suppression)

At this time, the image pick-up blur suppressing section 2 carries out the image pick-up blur suppression as described in the following. That is, the image pick-up blur suppressing section 2 corrects every pixel value in the input video image configured of the video signal D1 by each frame period using the motion vector mv, thereby suppressing the image pick-up blur contained in this video signal D1 and generating the video signal D2.

More specifically, first, as shown in FIG. 2, the estimated value generating section 21 calculates an estimated value Est(n), based on the motion vector mv, the video signal D1 (pixel data IB(n)), and the estimated value Est(n−mv).

Next, in the corrected value calculating section 22, the trust information calculating section 223 generates the trust information Trst(n), based on the image data IB(n−mv/2) and the estimated value Est(n).

Then, in this corrected value calculating section 22, the corrected value generating section 222 generates the estimated value Est(n) and the video signal D2 (output pixel data Out(n)), based on the image data IB(n), the estimated value Est(n), and the trust information Trst(n−mv).

In this manner, the image pick-up blur suppressing section 2 makes a sequential correction to every pixel value in each frame period and, at the time of the correction in a target pixel “n”, makes the correction by utilizing a correction result in the pixel that has been corrected (corrected pixel) in the input video image within the current frame period. In this way, such a correction (the above-described operation of the formula (9)) functions as an IIR filter processing in a spatial direction.

As described above, in the present embodiment, the image pick-up blur suppressing section 2 makes a sequential correction to every pixel value in each frame period and, at the time of the correction in a target pixel “n”, makes the correction by utilizing the correction result in the pixel that has been corrected (corrected pixel) in the input video image within the current frame period, so that such a correction may function as the IIR filter processing in a spatial direction. Consequently, the image pick-up blur may be suppressed also in the input video signal containing a spatial frequency component higher than that in the past, making it possible to improve the image quality including the image pick-up blur in a more appropriate manner (obtain a sharp image).

### Modifications of First Embodiment

In the following, modifications of the first embodiment will be described. The constituent elements that are the same as those in the first embodiment will be assigned the same reference signs, and the description thereof will be omitted suitably.

### Modification 1

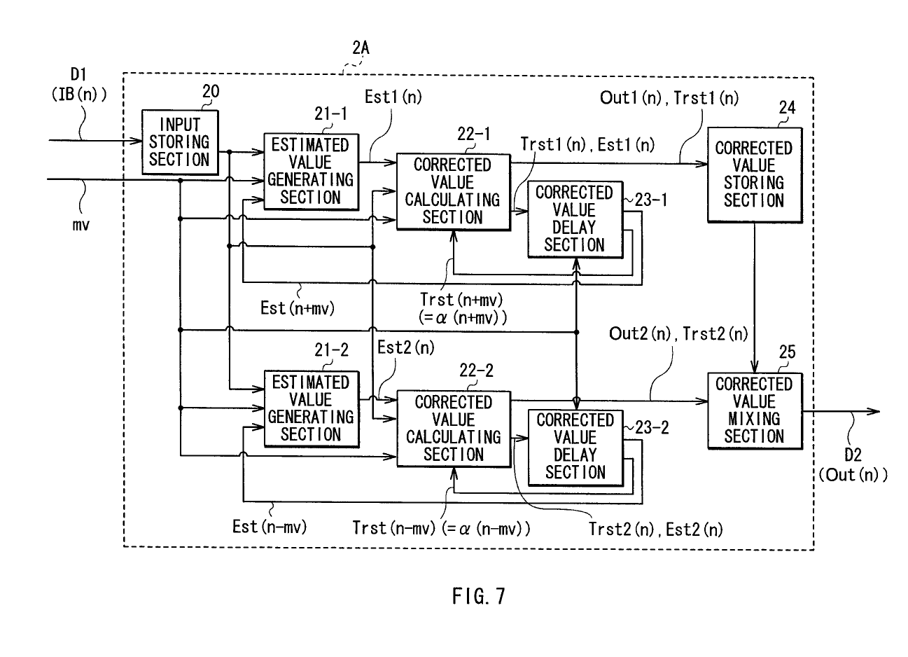

FIG. 7 shows a block structure of an image pick-up blur suppressing section 2A according to modification 1. This image pick-up blur suppressing section 2A has an input storing section 20, two estimated value generating sections 21-1 and 21-2, two corrected value calculating sections 22-1 and 22-2, two corrected value delay sections 23-1 and 23-2, a corrected value storing section 24, and a corrected value mixing section 25. The image pick-up blur suppressing section 2A is different from the image pick-up blur suppressing section 2 described in the first embodiment, in that the two estimated value generating sections whose processing directions are opposite to each other, etc. are provided. In other words, by obtaining a correction result in a corrected pixel from a plurality of corrected pixels that are different from each other and mixing a plurality of corrected values that are obtained using each of the plurality of correction results, an ultimate corrected value in a target pixel “n” is obtained.

The input storing section 20 stores data within a predetermined range in a video signal D1 (pixel data IB(n)).

The estimated value generating section 21-1, the corrected value calculating section 22-1, and the corrected value delay section 23-1 operate similarly to the first embodiment described above. That is, the estimated value generating section 21-1 obtains an estimated value Est1(n), based on a motion vector mv, the video signal D1 (pixel data IB(n)), and an estimated value Est(n+mv) outputted from the corrected value delay section 23-1. The corrected value calculating section 22-1 generates the trust information Trst1(n), based on the image data IB(n+mv/2) obtained from the pixel data IB(n) and the estimated value Est1(n). Further, the corrected value calculating section 22-1 generates the estimated value Est1(n) and output pixel data Out1(n), based on the image data IB(n), the estimated value Est1(n), and the trust information Trst1(n+mv) outputted from the corrected value delay section 23-1.

The estimated value generating section 21-2, the corrected value calculating section 22-2, and the corrected value delay section 23-2 also operate similarly to the first embodiment described above. That is, the estimated value generating section 21-2 obtains an estimated value Est2(n), based on a motion vector mv, the video signal D1 (pixel data IB(n)), and an estimated value Est(n−mv) outputted from the corrected value delay section 23-2. The corrected value calculating section 22-2 generates the trust information Trst2(n), based on the image data IB(n−mv/2) obtained from the pixel data IB(n) and the estimated value Est2(n). Further, the corrected value calculating section 22-2 generates the estimated value Est2(n) and output pixel data Out2(n), based on the image data IB(n), the estimated value Est2(n), and the trust information Trst2(n−mv) outputted from the corrected value delay section 23-2.

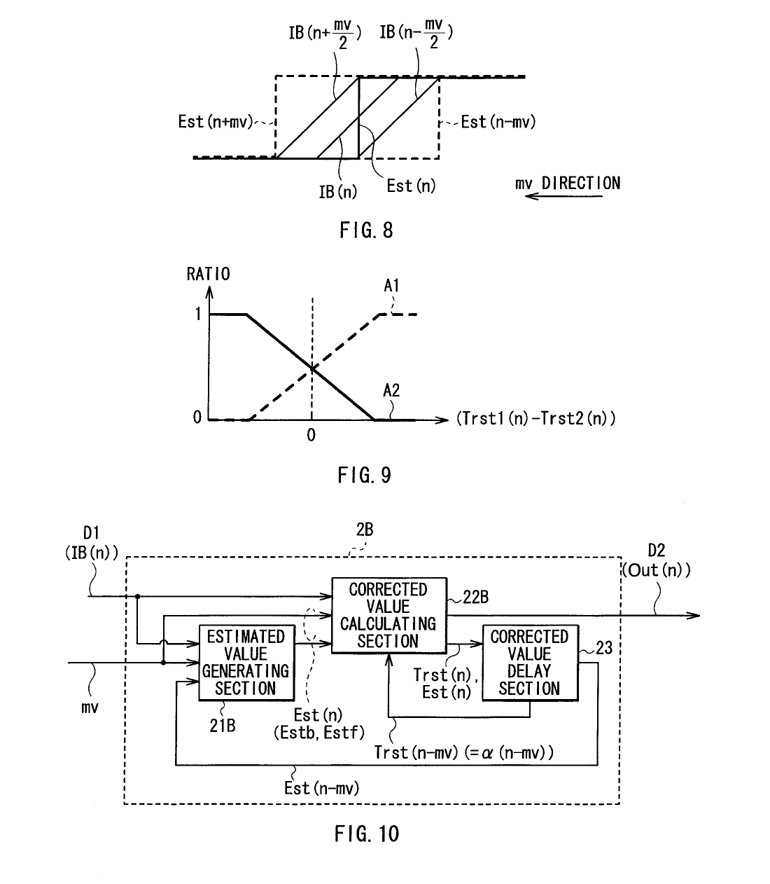

FIG. 8 shows a phase relationship between the image data IB(n), IB(n−mv/2), IB(n+mv/2) configured by adding an image pick-up blur to a step image and the estimated values Est(n), Est(n−mv/2), Est(n+mv/2).

The corrected value storing section 24 stores the estimated value Est1(n) and the output pixel data Out1(n) outputted from the corrected value calculating section 22-1.

In accordance with the ratio of the trust information Trst1(n) to the trust information Trst2(n) outputted from the corrected value storing section or the corrected value calculating section 22-2, the corrected value mixing section 25 mixes two corrected values (the values of the output pixel data Out1(n) and Out2(n)) outputted from these sections. More specifically, as shown in FIG. 9, the corrected value mixing section 25 generates the ultimate output pixel data Out(n) while changing the ratio of coefficients A1 and A2 in the formula Out(n)=A1×Out1(n)+A2×Out2(n), according to the value of (Trst1(n)−Trst2(n)), for example.

As described above, the present modification provides the two estimated value generating sections 21-1 and 21-2 whose processing directions are opposite to each other, etc., making it possible to obtain an estimated value with a higher likelihood from a plurality of estimated values as a method for raising the likelihood of the estimated value.

Further, in the corrected value mixing section 25, the individual estimated values are mixed according to the ratio of the degree of trust, making it possible to obtain an estimated value with an even higher trust.

### Modification 2

FIG. 10 shows a block structure of an image pick-up blur suppressing section 2B according to modification 2. This image pick-up blur suppressing section 2B has an estimated value generating section 21B, a corrected value calculating section 22B, and a corrected value delay section 23. The image pick-up blur suppressing section 2B is different from that in the first embodiment described above, in that a plurality of stages of delay elements are combined so as to obtain a plurality of estimated values, though the processing is carried out in one direction unlike modification 1 described above.

The estimated value generating section 21B obtains two estimated values Est(n) (Estb and Estf), based on the motion vector mv, the video signal D1 (pixel data IB(n)), and an estimated value Est(n−mv) outputted from the corrected value delay section 23.

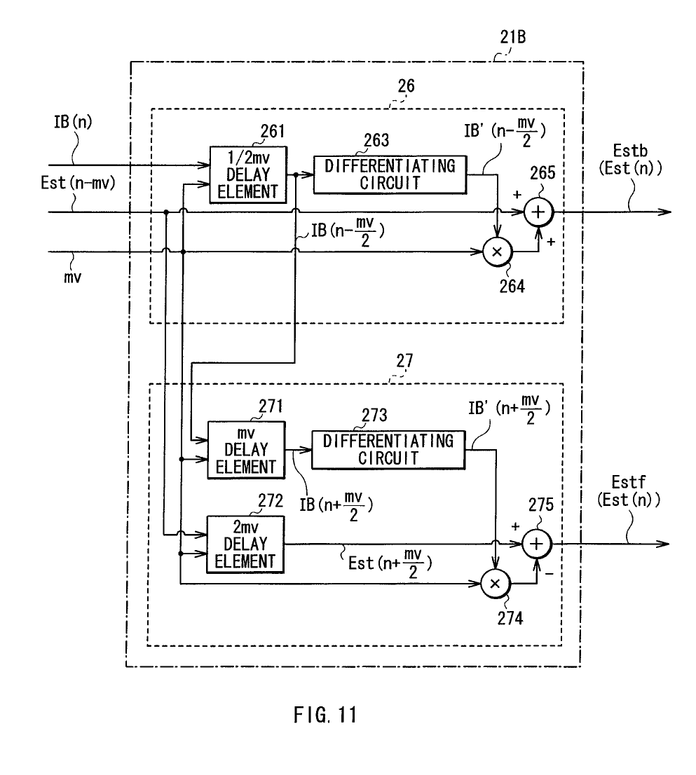

FIG. 11 shows the detailed structure of this estimated value generating section 21B. The estimated value generating section 21B has two generating sections 26 and 27.

The generating section 26 generates the estimated value Estb, and has a (1/2)mv delay element 261, a differentiating circuit 263, a multiplier 264, and an adder 265. More specifically, the (1/2)mv delay element 261 generates image data IB(n−mv/2) corresponding to a pixel position that is delayed by a pixel corresponding to the value of mv/2, based on the image data IB(n) and the motion vector mv. The differentiating circuit 263 performs a differential operation based on the image data IB(n−mv/2) outputted from the (1/2)mv delay element 261, thereby generating a pixel differentiation value IB′(n−mv/2) in the direction of sequential correction. The multiplier 264 multiplies the pixel differentiation value IB′(n−mv/2) outputted from the differentiating circuit 263 by the motion vector mv. The adder 265 adds the multiplied value of the multiplier 264 and an estimated value Est(n−mv) together, thereby generating an estimated value Estb.

The generating section 27 generates the estimated value Estf, and has an mv delay element 271, a 2mv delay element 272, a differentiating circuit 273, a multiplier 274, and an adder 275. More specifically, the mv delay element 271 generates image data IB(n+mv/2) corresponding to a pixel position that is delayed by a pixel corresponding to the value of mv, based on the image data IB(n−mv/2) outputted from the (1/2)mv delay element 261 and the motion vector mv. The 2mv delay element 272 generates an estimated value Est(n+mv/2) corresponding to a pixel position that is delayed by a pixel corresponding to the value of 2mv, based on the estimated value Est(n−mv) and the motion vector mv. The differentiating circuit 273 performs a differential operation based on the image data IB(n+mv/2) outputted from the mv delay element 271, thereby generating a pixel differentiation value IB′(n+mv/2) in the direction of sequential correction. The multiplier 274 multiplies the pixel differentiation value IB′(n+mv/2) outputted from the differentiating circuit 273 by the motion vector mv. The adder 275 adds a negative (−) value of the multiplied value of the multiplier 274 and an estimated value Est(n+mv/2) together, thereby generating an estimated value Estf.

The corrected value calculating section 22B generates an estimated value Est(n), output pixel data Out(n), and trust information Trst(n), based on the pixel data IB(n), the motion vector mv, and the two estimated values Estb and Estf outputted from the estimated value generating section 21B.

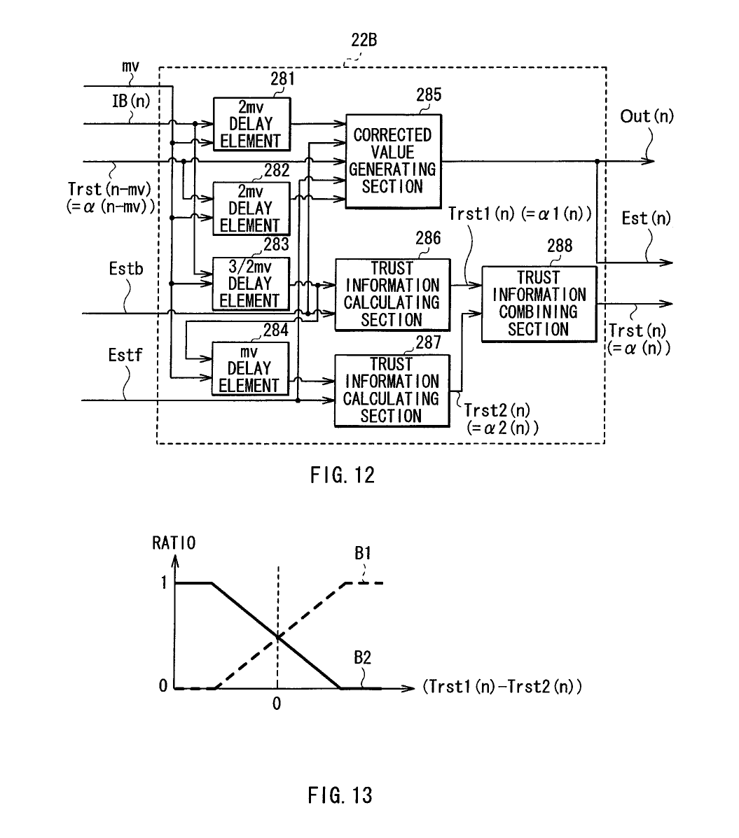

FIG. 12 shows the detailed structure of the corrected value calculating section 22B. The corrected value calculating section 22B has two 2mv delay elements 281 and 282, a (3/2)mv delay element 283, an mv delay element 284, a corrected value generating section 285, two trust information calculating sections 286 and 287, and a trust information combining section 288.

The 2mv delay element 281 generates image data IB(n−2mv/2) corresponding to a pixel position that is delayed by a pixel corresponding to the value of 2mv, based on the image data IB(n) and the motion vector mv. The 2mv delay element 282 generates trust information Trst(n−2mv) corresponding to a pixel position that is delayed by a pixel corresponding to the value of 2mv, based on the trust information Trst(n−mv) and the motion vector mv. The (3/2)mv delay element 283 generates image data IB(n−3mv/2) corresponding to a pixel position that is delayed by a pixel corresponding to the value of (3/2)mv, based on the image data IB(n) and the motion vector mv. The mv delay element 284 generates image data IB(n−mv/2) corresponding to a pixel position that is delayed by a pixel corresponding to the value of mv, based on the image data IB(n−3mv/2) outputted from the (3/2)mv delay element 283 and the motion vector mv.

The corrected value generating section 285 generates the output pixel data Out(n) and the estimated value Est(n). More specifically, the corrected value generating section 285 generates them based on the two estimated values Estb and Estf, the image data IB(n−2mv/2) outputted from the 2mv delay element 281, the trust information Trst(n−mv), and the trust information Trst(n−2mv) outputted from the 2mv delay element 282.

The trust information calculating section 286 generates the trust information Trst1(n) (=α1(n)), based on the estimated value Estb and the image data IB(n−3mv/2) outputted from the (3/2)mv delay element 283. The trust information calculating section 287 generates the trust information Trst2(n) (=α2(n)), based on the estimated value Estf and the image data IB(n−mv/2) outputted from the mv delay element 284.

The trust information combining section 288 mixes the values of the trust information Trst1(n) and the trust information Trst2(n) outputted from the trust information calculating sections 286 and 287 according to the ratio of these values, thereby generating ultimate trust information Trst(n). More specifically, as shown in FIG. 13, for example, the trust information Trst(n) is generated by changing the ratio of coefficients B1 and B2 in the formula Trst(n)=B1×Trst1(n)+B2×Trst2(n), according to the value of (Trst1(n)−Trst2(n)).

As described above, the present modification combines a plurality of stages of delay elements so as to obtain a plurality of estimated values, making it possible to obtain an estimated value with a higher likelihood from the plurality of estimated values as a method for raising the likelihood of the estimated value, similarly to modification 1 described above.

Further, in the trust information combining section 288, the two pieces of trust information are mixed according to the ratio of the values of them, making it possible to obtain trust information with a high trust.

### 2. Second Embodiment

### [Structure of Image Pick-Up Blur Suppressing Section 3]

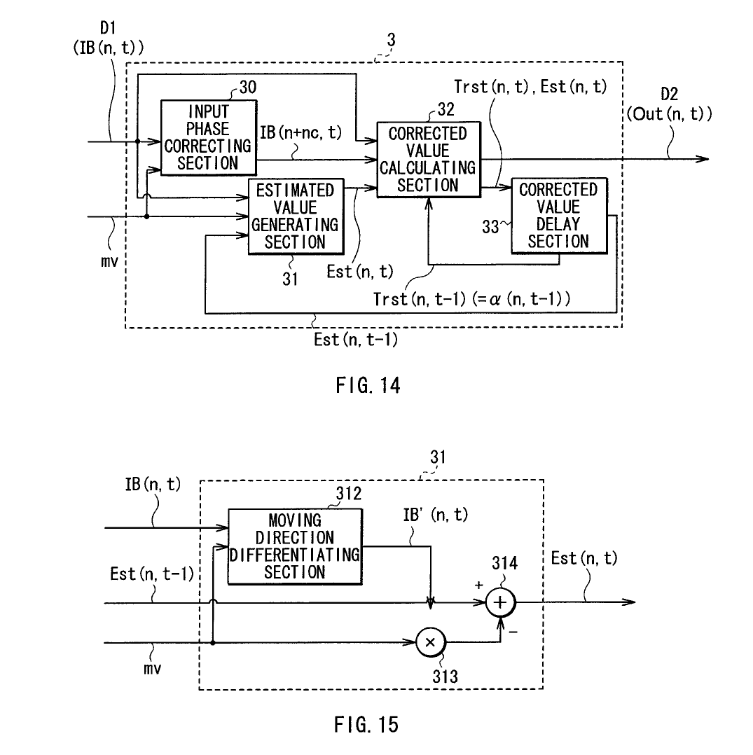

FIG. 14 shows a block structure of an image pick-up blur suppressing section 3 according to the second embodiment. The image pick-up blur suppressing section 3 has an input phase correcting section 30, an estimated value generating section 31, a corrected value calculating section 32, and a corrected value delay section 33.

### (Input Phase Correcting Section 30)

The input phase correcting section 30 generates pixel data IB(n+nc, t), based on a video signal D1 (pixel data IB(n, t); with “t” indicating the t-th frame period) and a motion vector mv. Such pixel data IB(n+nc, t) correspond to pixel data obtained by subjecting the pixel data IB(n, t) to a phase correction by a phase correction amount nc. Incidentally, such a phase correction is made for the following reason. That is, first, the pixel data IB(n, t) containing an image pick-up blur accompanies a phase change compared with the case in which the image pick-up blur is removed. Also, such a phase change becomes larger when the correction amount to the pixel data IB(n, t) is greater. Thus, the phase correction amount nc serves as a parameter for reducing a displacement amount due to such a phase change.

### (Estimated Value Generating Section 31)

The estimated value generating section 31 obtains an estimated value Est(n, t) of a corrected value in a target pixel “n” within the current frame period “t”, based on the motion vector mv, the pixel data IB(n, t), and an estimated value Est(n, t−1) outputted from a corrected value delay section 33, which will be described later.

FIG. 15 shows the detailed structure of this estimated value generating section 31. The estimated value generating section 31 has a moving direction differentiating circuit 312, a multiplier 313, and an adder 314.

The moving direction differentiating circuit 312 performs a predetermined differential operation, which is expressed by the formulae (16) and (17) below similarly to the formulae (2) and (3) described above, based on the image data IB(n, t) and the motion vector mv. In this way, a pixel differentiation value IB′(n, t) is generated in the direction of sequential correction (moving direction).

$$\begin{matrix}IB ( n ) = \frac{{\sum }_{n + mv - 1}^{n} Ireal ( n )}{\vert mv \vert} & ( 16 ) \\ {IB}^{′} ( n ) = \frac{Ireal ( n + mv ) - Ireal ( n )}{\vert mv \vert} & ( 17 )\end{matrix}$$

The multiplier 313 multiplies the pixel differentiation value IB′(n, t) outputted from the moving direction differentiating circuit 312 by the motion vector mv. The adder 314 adds a negative (−) value of the multiplied value of the multiplier 313 and an estimated value Est(n, t−1) in a frame period (t−1), which lies one period before (precedes) the current frame period, together, thereby generating an estimated value Est(n, t) in the current frame period t.

More specifically, these operations may be expressed by the formulae below. First, the formula (17) described above may be rewritten as the formula (18) below. Also, from this formula (18), when a pixel that is located away from the target pixel “n” by the motion vector mv is free from an image pick-up blur, an image without an image pick-up blur (an estimate of the image data; estimated value Est(n, t)) may be obtained as follows. That is, first, when the formula (18) is rearranged to yield the form using information between frames, the formula (19) below is obtained. Thus, from this formula (19), the formula (20) below for obtaining the estimated value Est(n, t) is obtained. This formula (20) obtains the estimated value Est(n, t) in the current frame period “t” using the estimated value Est(n, t−1) in a frame period (t−1), which lies one period before (precedes) the current frame period. On the other hand, it is also possible to obtain the estimated value Est(n, t) in the current frame period “t” using the estimated value Est(n, t+1) in a frame period (t+1), which lies one period after the current frame period. More specifically, assuming that the same linear movement also continues after one frame period, information at a pixel position after one frame period is considered to have moved from information at a pixel position before one frame period by 2mv. Thus, the estimated value Est(n, t) in the current frame period “t” may be obtained using the estimated value Est(n, t+1) in the frame period (t+1), which is one frame after the current frame period, by the formula (21) below.

$$\begin{matrix}Ireal ( n ) = Ireal ( n + mv ) - {IB}^{′} ( n ) \cdot \vert mv \vert & ( 18 ) \\ Ireal ( n , t ) = Ireal ( n , t - 1 ) - {IB}^{′} ( n , t ) \cdot \vert mv \vert & ( 19 ) \\ [ \begin{matrix}Est ( n , t ) = Est ( n , t - 1 ) - {IB}^{′} ( n , t ) \cdot \vert mv \vert & \\ Est ( n , t ) = Est ( n - 2 mv , t - 1 ) + {IB}^{′} ( n , t + 1 ) \cdot \vert mv \vert & \end{matrix} & \begin{matrix}( 20 ) \\ ( 21 )\end{matrix}\end{matrix}$$

### (Corrected Value Calculating Section 32)

The corrected value calculating section 32 calculates a corrected value based on the pixel data IB(n, t), the pixel data IB(n+nc, t) outputted from the input phase correcting section 30, the estimated value Est(n, t) outputted from the estimated value generating section 31, and trust information Trst(n, t−1) outputted from the corrected value delay section 33, which will be described later. More specifically, the corrected value calculating section 32 outputs the trust information Trst(n, t) and the estimated value Est(n, t) to the corrected value delay section 33, and outputs a video signal D2 (output pixel data Out(n, t)).

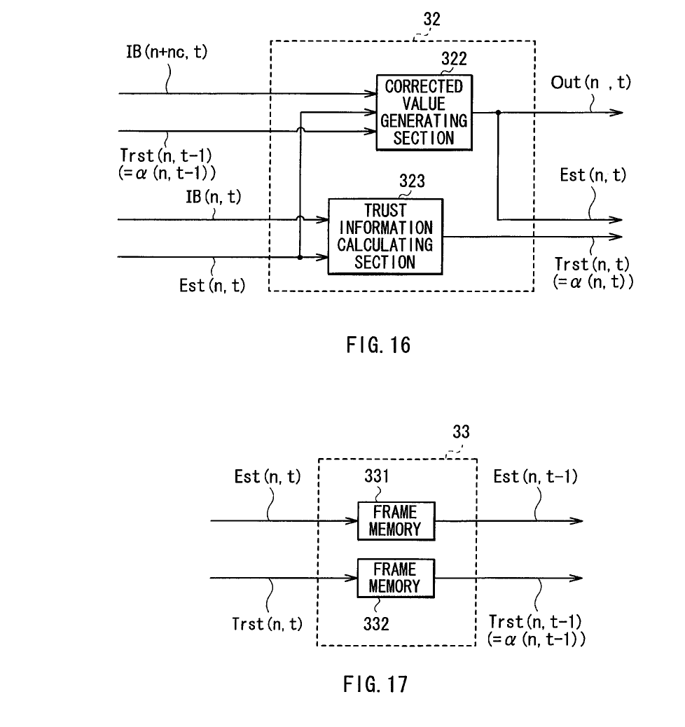

FIG. 16 shows the detailed structure of the corrected value calculating section 32. The corrected value calculating section 32 has a corrected value generating section 322 and a trust information calculating section 323.

The corrected value generating section 322 generates the estimated value Est(n, t) and the output pixel data Out(n, t) by using the formula (22) below, based on the image data IB(n+nc, t), the estimated value Est(n, t), and the trust information Trst(n, t−1). The operation expressed by this formula (22) has a so-called HR filter configuration. It is noted that, in the formula (22), α indicates an update coefficient, which may be a value from 0 to 1, and the value of the update coefficient α may be changed suitably. Further, from the formula (22), it is understood that the correction level for the target pixel “n” is controlled using this update coefficient α.

The trust information calculating section 323 generates the trust information Trst(n, t) (=α(n, t)) using the formulae (23) and (24) below, based on the image data IB(n, t) and the estimated value Est(n, t).

More specifically, the trust information Trst(n, t) is obtained as follows. First, the likelihood of the estimated value Est(n, t) depends on the correction result in the preceding frame period (t−1) in the target pixel “n”. Therefore, the likelihood is considered to be higher as the difference value is smaller between the correction result (corrected value) and the original pixel value containing the image pick-up blur in this preceding frame period. Thus, with respect to the likelihood of the estimated value Est(n, t), for example, when the correction amount in the preceding frame period is given as Δ, the trust information Trst(n, t−1) may be expressed by a function F(Δ) of this correction amount Δ and used as the update coefficient α described above. Accordingly, the trust information Trst(n, t−1) (=α(n, t−1)) is expressed by the formulae (23) and (24) below. Incidentally, this function F(Δ) is expressed by a function that decreases consistently with respect to the correction amount Δ and, for example, (1−Δ).

$$\begin{matrix}Out ( n , t ) = ( Est ( n , t ) ) - IB ( n + {n}_{c} , t ) ) \cdot α + IB ( n + {n}_{c} , t ) & ( 22 ) \\ [ \begin{matrix}Δ ( n , t - 1 ) = ( Est ( n , t - 1 ) - IB ( n , t - 1 ) ) & \\ Trst ( n , t - 1 ) = F ( Δ ( n , t - 1 ) ) & \end{matrix} & \begin{matrix}( 23 ) \\ ( 24 )\end{matrix}\end{matrix}$$

Further, when the value of the trust information Trst(n, t−1) is large, the likelihood of the estimated value Est(n, t) as the correction result is also high. Therefore, the likelihood as high as the trust information Trst(n, t−1) may be set to the trust information Trst(n, t). In other words, the trust information Trst(n, t) may be expressed by the formulae (25) and (26) below.

$$[ \begin{matrix}\begin{matrix}Trst ( n , t ) = Trst ( n , t - 1 ) in the case \\ of Trst ( n , t - 1 ) > F ( Δ ( n , t ) )\end{matrix} & \\ \begin{matrix}Trst ( n , t ) = F ( Δ ( n , t ) ) in the case \\ of Trst ( n , t - 1 ) \leq F ( Δ ( n , t ) )\end{matrix} & \end{matrix} \qquad \begin{matrix}( 25 ) \\ ( 26 )\end{matrix}$$

Moreover, when the update coefficient α varies considerably by each frame, flicker is sometimes perceived in the motion image. Accordingly, in order to reduce this flicker, it is also possible to set two predetermined constants k1 and k2 and express the trust information Trst(n, t) by the formulae (27) and (28) below.

$$[ \begin{matrix} Trst ( n , t = k 1 \cdot F ( Δ ( n , t ) ) in the case of Trst ( n , t - 1 ) > k 1 \cdot & ( 27 ) \\ F ( Δ ( n , t ) ) & \\ Trst ( n , t ) = F ( Δ ( n , t ) ) \cdot k 2 + Trst ( n , t - 1 ) \cdot ( 1 - k 2 ) in the case & ( 28 ) \\ of Trst ( n , t - 1 ) \leq k 1 \cdot F ( Δ ( n , t ) ) & \end{matrix}$$

In addition, in an image containing noise, the trust information Trst(n, t) is also affected. Thus, it is also effective to perform a suitable LPF processing with neighboring pixels within the frame period. Further, there is a possibility that the correction amount Δ increases due to a noise component, so that the value of the trust information Trst(n, t) could be estimated to be smaller than necessary. Thus, it is also appropriate to detect the noise component and perform gain control of the value of the correction amount Δ according to the noise component.

### (Corrected Value Delay Section 33)

The corrected value delay section 33 stores (holds) the trust information Trst(n, t) and the estimated value Est(n, t) outputted from the corrected value calculating section 32, and functions as a delay element of one frame period.

FIG. 17 shows the detailed structure of the corrected value delay section 33. The corrected value delay section 33 has two frame memories 331 and 332.

The frame memory 331 generates the estimated value Est(n, t−1) that is delayed by one frame period, based on the estimated value Est(n, t). The frame memory 332 generates the trust information Trst(n, t−1) that is delayed by one frame period, based on the trust information Trst(n).

### [Effects of the Image Pick-Up Blur Suppressing Section 3]

Now, the effects of the image pick-up blur suppressing section 3 will be described. It should be noted that, since the effects (basic operation) of the entire display unit are similar to those of the display unit 1 of the first embodiment described above, the description thereof will be omitted.

### (Image Pick-Up Blur Suppression)

In this image pick-up blur suppressing section 3, first, the input phase correcting section 30 generates pixel data IB(n+nc, t), which is formed by subjecting the pixel data IB(n, t) to a phase correction by a phase correction amount nc, based on pixel data IB(n, t) and a motion vector mv.

Next, the estimated value generating section 31 calculates an estimated value Est(n, t) in the current frame period “t” based on the motion vector mv, the pixel data IB(n, t) and an estimated value Est(n, t−1) in the preceding frame period (t−1).

Subsequently, in the corrected value calculating section 32, the trust information calculating section 323 generates the trust information Trst(n, t) based on the image data IB(n, t) and the estimated value Est(n, t).

Then, in this corrected value calculating section 32, the corrected value generating section 322 generates the estimated value Est(n, t) and the output pixel data Out(n, t), based on the image data IB(n+nc, t), the estimated value Est(n, t), and the trust information Trst(n, t−1).

In this manner, at the time of the correction in a target pixel “n” within each frame period, the image pick-up blur suppressing section 3 makes the correction by utilizing a correction result in the same pixel that has been corrected (corrected pixel) in the preceding frame period. In this way, such a correction (the above-described operation of the formula (22)) functions as an IIR filter processing in a time direction.

As described above, in the present embodiment, at the time of the correction in a target pixel “n” within each frame period, the image pick-up blur suppressing section 3 makes the correction by utilizing the correction result in the same pixel that has been corrected (corrected pixel) in the preceding frame period, so that such a correction may function as the IIR filter processing in a time direction. Consequently, the image pick-up blur may be suppressed also in the input video signal containing a spatial frequency component higher than that in the past, making it possible to improve the image quality including the image pick-up blur in a more appropriate manner (obtain a sharp image).

### Modifications of Second Embodiment

In the following, modifications of the second embodiment will be described. The constituent elements that are the same as those in the second embodiment will be assigned the same reference signs, and the description thereof will be omitted suitably.

### Modification 3

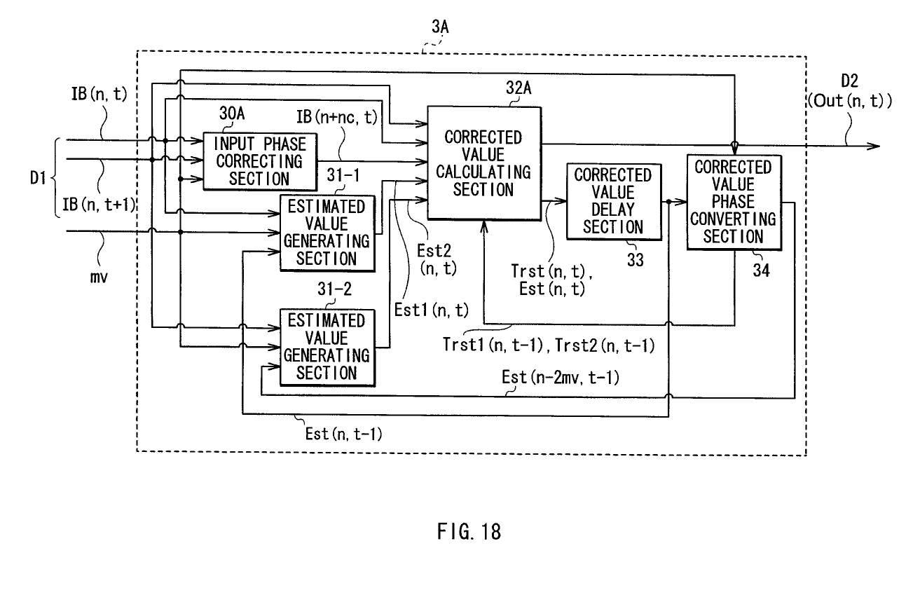

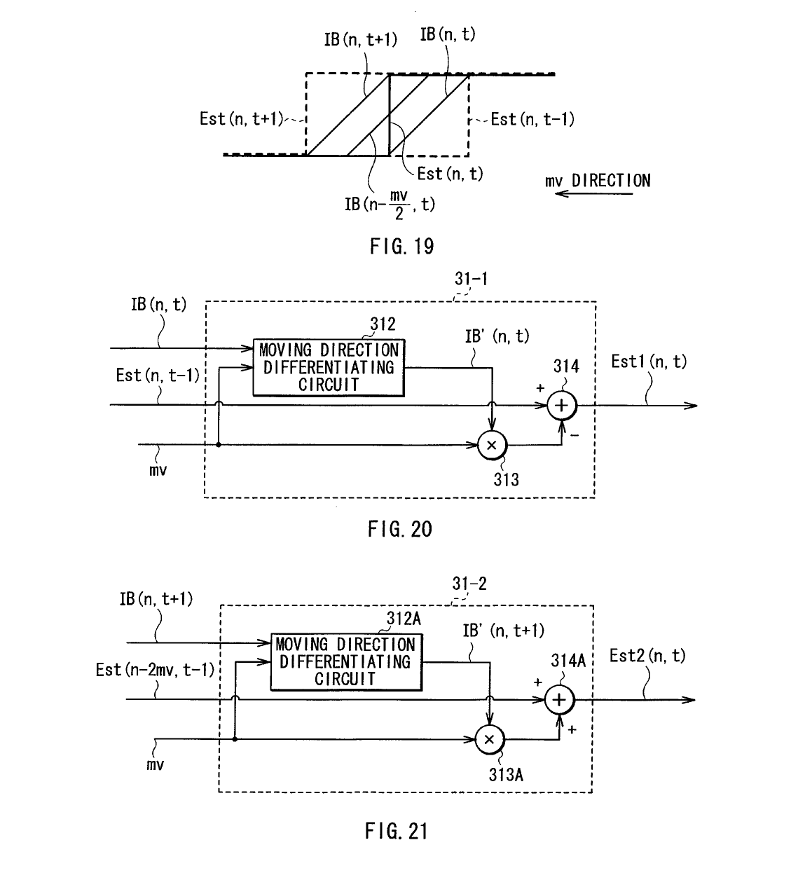

FIG. 18 shows a block structure of an image pick-up blur suppressing section 3A according to modification 3. This image pick-up blur suppressing section 3A has an input phase correcting section 30A, two estimated value generating sections 31-1 and 31-2, a corrected value calculating section 32A, a corrected value delay section 33, and a corrected value phase converting section 34. The image pick-up blur suppressing section 3A is different from that in the second embodiment, in that an estimated value is obtained also from information after one frame period so as to improve the likelihood of the estimated value. In other words, by obtaining correction results in corrected pixels from corrected pixels in a plurality of frame periods that are different from each other and mixing a plurality of corrected values that are obtained using each of the plurality of correction results, an ultimate corrected value is obtained.

FIG. 19 shows a phase relationship between image data IB(n, t), IB(n−mv/2, t), IB(n, t+1) formed by adding an image pick-up blur to a step image and estimated values Est(n, t−1), Est(n, t), Est(n, t+1).

The input phase correcting section 30A generates pixel data IB(n+nc, t) formed by a phase correction, based on the pixel data IB(n, t) and IB(n+1, t) and the motion vector mv.

The estimated value generating section 31-1 calculates an estimated value Est1(n, t) in the current frame period “t”, based on the motion vector mv, the pixel data IB(n, t), and an estimated value Est(n, t−1) outputted from the corrected value delay section 33, which will be described later.

FIG. 20 shows the detailed structure of this estimated value generating section 31-1. The estimated value generating section 31-1 has a moving direction differentiating circuit 312, a multiplier 313, and an adder 314 similarly to the estimated value generating section 31 described in the second embodiment.

In this way, the estimated value generating section 31-1 calculates the estimated value Est1(n, t) in the current frame period “t” using the estimated value Est(n, t−1) in the preceding frame period (t−1) by the formula (20) described above.

The estimated value generating section 31-2 calculates an estimated value Est2(n, t) in the current frame period “t”, based on the motion vector mv, the pixel data IB(n, t+1), and an estimated value Est(n−2mv, t−1) outputted from the corrected value phase converting section 34, which will be described later.

FIG. 21 shows the detailed structure of this estimated value generating section 31-2. The estimated value generating section 31-2 has a moving direction differentiating circuit 312A, a multiplier 313A, and an adder 314A.

The moving direction differentiating circuit 312A performs a predetermined differential operation, which is similar to the formulae (16) and (17) described above, based on the image data IB(n, t+1) and the motion vector mv. In this way, a pixel differentiation value IB′(n, t+1) is generated in the direction of sequential correction (moving direction).

The multiplier 313A multiplies the pixel differentiation value IB′(n, t+1) outputted from the moving direction differentiating circuit 312A by the motion vector mv. The adder 314A adds the multiplied value of the multiplier 313A and an estimated value Est(n−2mv, t−1) together, thereby generating an estimated value Est2(n, t) in the current frame period “t” by the formula (21) described above.

The corrected value calculating section 32A calculates a corrected value, based on the pixel data IB(n, t), the pixel data IB(n, t+1), IB(n+nc, t), the two estimated values Est1(n), Est2(n), and two pieces of trust information Trst1(n, t−1), Trst2(n, t−1) outputted from the corrected value phase converting section 34, which will be described later. More specifically, the corrected value calculating section 32A outputs the trust information Trst(n, t) and the estimated value Est(n, t) to the corrected value delay section 33 and outputs output pixel data Out(n, t).

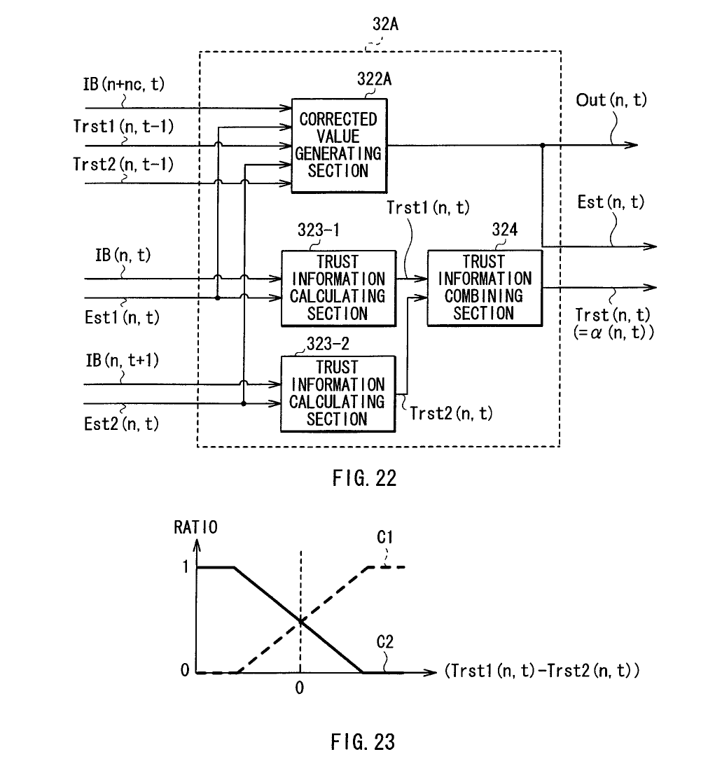

FIG. 22 shows the detailed structure of the corrected value calculating section 32A. The corrected value calculating section 32A has a corrected value generating section 322A, two trust information calculating sections 323-1 and 323-2, and a trust information combining section 324.

The corrected value generating section 322A generates the estimated value Est(n, t) and the output pixel data Out(n, t), based on the image data IB(n+nc, t), the two estimated values Est1(n, t), Est2(n, t), and the two pieces of trust information Trst1(n, t−1), Trst2(n, t−1). At this time, the corrected value generating section 322A mixes the two estimated values Est1(n, t) and Est2(n, t), according to the ratio of the values of the trust information Trst1(n, t−1) and the trust information Trst2(n, t−1). More specifically, as shown in FIG. 23, the corrected value generating section 322A generates the ultimate output pixel data Out(n, t) while changing the ratio of coefficients C1 and C2 in the formula Est(n, t) (Out(n, t))=C1×Est1(n, t)+C2×Est2(n, t), according to the value of (Trst1(n, t−1)−Trst2(n, t−1)), for example.

The trust information calculating section 323-1 generates the trust information Trst1(n, t) (=α1(n, t)) using the formulae (23) and (24) described above, based on the image data IB(n, t) and the estimated value Est1(n, t). The trust information calculating section 323-2 generates the trust information Trst2(n, t) (=α2(n, t)) using the formulae (23) and (24) described above, based on the image data IB(n, t+1) and the estimated value Est2(n, t).

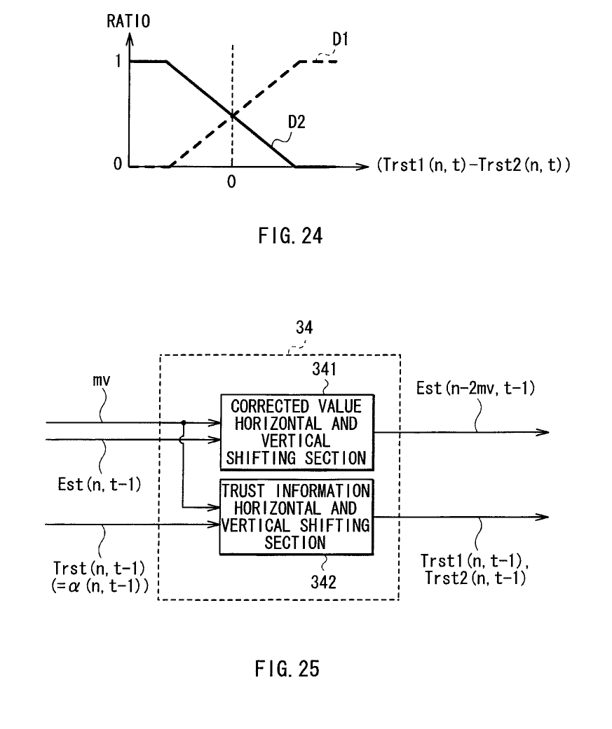

The trust information combining section 324 mixes the values of the trust information Trst1(n, t) and the trust information Trst2(n, t) outputted from the trust information calculating sections 323-1 and 323-2 according to the ratio of these values, thereby generating ultimate trust information Trst(n, t). More specifically, as shown in FIG. 24, for example, the trust information Trst(n, t) is generated by changing the ratio of coefficients D1 and D2 in the formula Trst(n, t)=D1×Trst1(n, t)+D2×Trst2(n, t), according to the value of (Trst1(n, t)−Trst2(n, t)).

The corrected value phase converting section 34 calculates the estimated value Est(n−2mv, t−1) shown in the formula (21) described above, based on the motion vector mv and the estimated value Est(n, t−1) outputted from the corrected value delay section 33. This corrected value phase converting section 34 also generates the two pieces of trust information Trst1(n, t) and Trst2(n, t), based on the motion vector mv and the trust information Trst(n, t−1) outputted from the corrected value delay section 33.

FIG. 25 shows the detailed structure of the corrected value phase converting section 34. The corrected value phase converting section 34 has a corrected value horizontal and vertical shifting section 341 and a trust information horizontal and vertical shifting section 342.

The corrected value horizontal and vertical shifting section 341 obtains the estimated value Est(n−2mv, t−1), based on the motion vector mv and the estimated value Est(n, t−1).

The trust information horizontal and vertical shifting section 342 generates the two pieces of trust information Trst1(n, t) and Trst2(n, t), based on the motion vector mv and the trust information Trst(n, t−1).

As described above, in the present modification, by obtaining correction results in corrected pixels from corrected pixels in a plurality of frame periods that are different from each other and mixing a plurality of corrected values that are obtained using each of the plurality of correction results, an ultimate corrected value is obtained. Accordingly, it becomes possible to improve the likelihood of the corrected value (estimated value).

### Modification 4

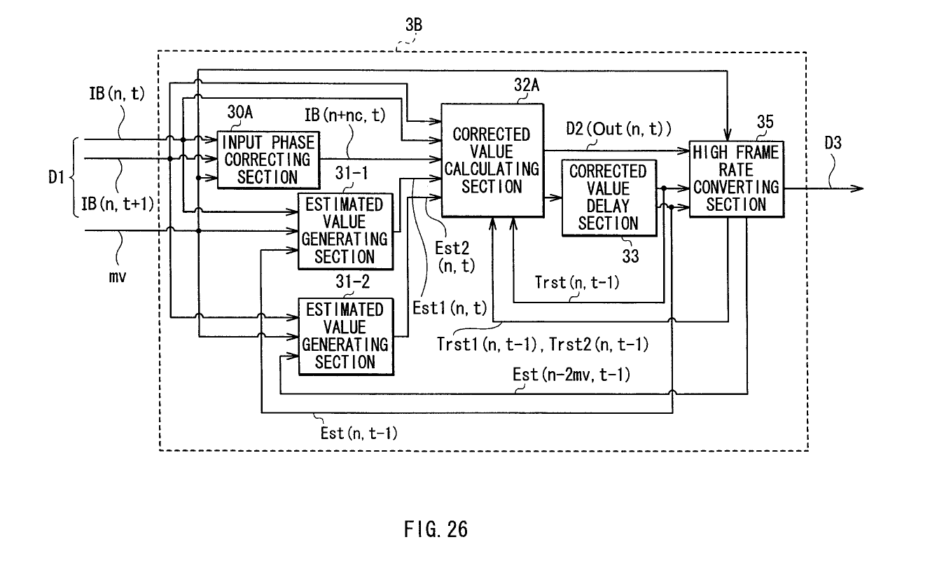

FIG. 26 shows a block structure of an image pick-up blur suppressing section 3B according to modification 4. This image pick-up blur suppressing section 3B has an input phase correcting section 30A, two estimated value generating sections 31-1 and 31-2, a corrected value calculating section 32A, a corrected value delay section 33, and a high frame rate converting section 35.

That is, the image pick-up blur suppressing section 3B is achieved by replacing the corrected value phase converting section 34 with the high frame rate converting section 35 in the image pick-up blur suppressing section 3A described in modification 2. In other words, in the display unit according to the present modification, the high frame rate converting section 35 that is integrated with the image pick-up blur suppressing section 3B is provided instead of the high frame rate converting section 13 described in FIG. 1.

The high frame rate converting section 35 generates a video signal D3 corresponding to an interpolated image, based on the motion vector mv and the video signal D2 (output pixel data Out(n, t)) outputted from the corrected value calculating section 32A.

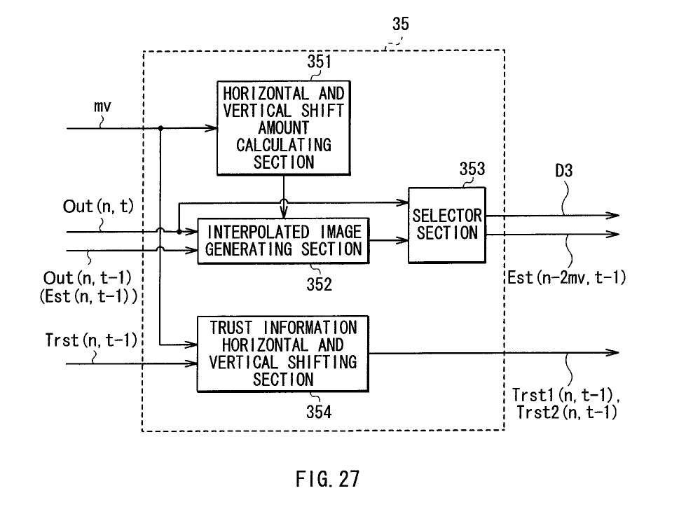

FIG. 27 shows the detailed structure of the high frame rate converting section 35. The high frame rate converting section 35 has a horizontal and vertical shift amount calculating section 351, an interpolated image generating section 352, a trust information horizontal and vertical shifting section 354, and a selector section 353.

The horizontal and vertical shift amount calculating section 351 calculates an image shift amount corresponding to an interpolation position, based on the motion vector mv.

The interpolated image generating section 352 reads out the image shift amount obtained by the horizontal and vertical shift amount calculating section 351 as an address value from a memory region, which is not shown, thereby generating an interpolated image based on the output pixel data Out(n, t). This interpolated image generating section 352 also reads out an image with an address value that is shifted by 2mv from the memory region, which is not shown, based on the output pixel data Out(n, t) outputted from the corrected value delay section 33, thereby generating an image at 2mv position.

The trust information horizontal and vertical shifting section 354 reads out information with an address value obtained by shifting the trust information Trst(n, t−1) by 2mv from the memory region, which is not shown. In this manner, the two pieces of trust information Trst1(n, t−1) and Trst2(n, t−1) are individually outputted from the trust information horizontal and vertical shifting section 354.

The selector section 353 switches, at a high frame rate, the interpolated image outputted from the interpolated image generating section 352 and the image corresponding to the output pixel data Out(n, t) in the current frame, thereby outputting the video signal D3. This selector section 353 also outputs the estimated value Est(n−2mv, t−1) corresponding to that after one frame, and supplies the same to the estimated value generating section 31-2.

As described above, in the present modification, the high frame rate converting section 35 is provided in such a manner as to be integrated with the image pick-up blur suppressing section 3B, making it possible to simplify the whole structure of the display unit.

### Modification 5

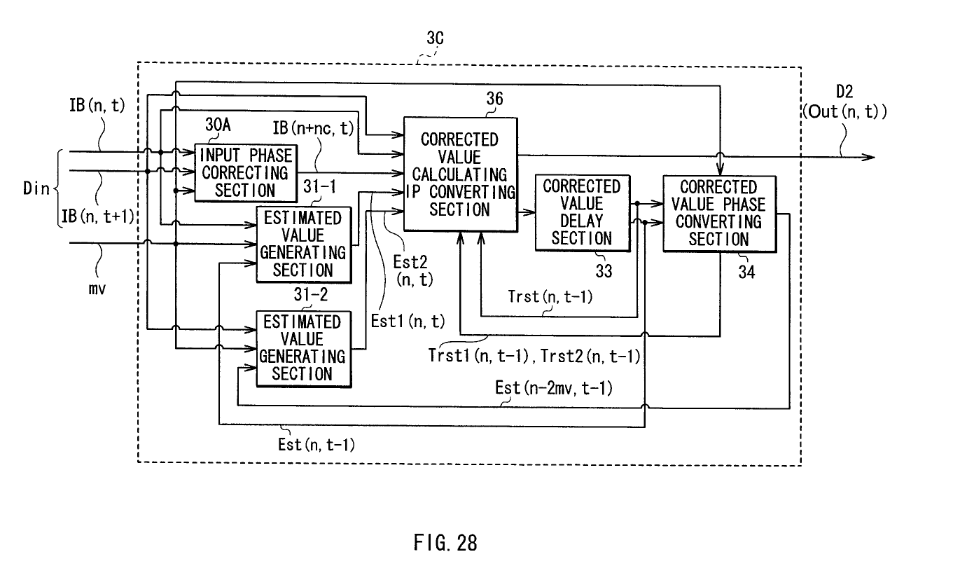

FIG. 28 shows a block structure of an image pick-up blur suppressing section 3C according to modification 5. This image pick-up blur suppressing section 3C has an input phase correcting section 30A, two estimated value generating sections 31-1 and 31-2, a corrected value calculating IP converting section 36, a corrected value delay section 33, and a corrected value phase converting section 34.

That is, the image pick-up blur suppressing section 3C is achieved by replacing the corrected value calculating section 32 with the corrected value calculating IP converting section 36 in the image pick-up blur suppressing section 3A described in modification 2. In other words, in the display unit according to the present modification, the corrected value calculating section and the IP converting section that are integrated with the image pick-up blur suppressing section 3C are provided instead of the IP converting section 11 described in FIG. 1.

The corrected value calculating IP converting section 36 calculates a corrected value, based on pixel data IB(n, t), pixel data IB(n, t+1), IB(n+nc, t), estimated values Est1(n), Est2(n), and trust information Trst(n, t−1), trust information Trst1(n, t−1), trust information Trst2(n, t−1). More specifically, the corrected value calculating IP converting section 36 outputs the trust information Trst(n, t) and the estimated value Est(n, t) to the corrected value delay section 33, and outputs the output pixel data Out(n, t).

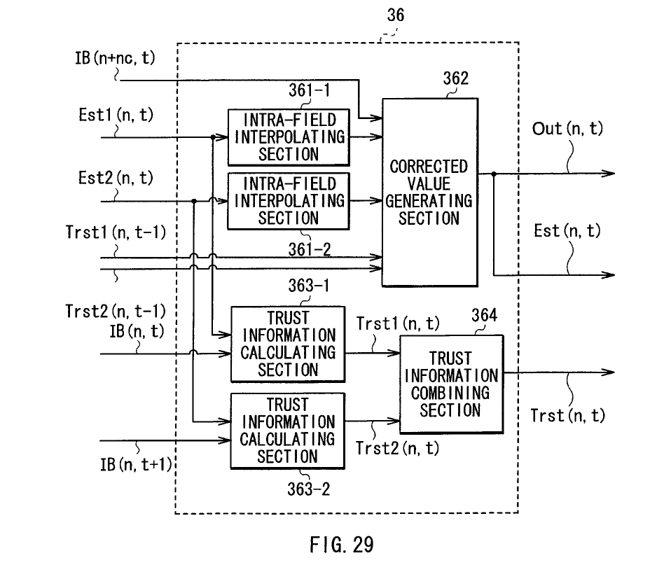

FIG. 29 shows the detailed structure of the corrected value calculating IP converting section 36. The corrected value calculating IP converting section 36 has two intra-field interpolating sections 361-1 and 361-2, a corrected value generating section 362, two trust information calculating sections 363-1 and 363-2, and a trust information combining section 364.

The intra-field interpolating section 361-1 interpolates an image of the estimated value Est1(n, t) corresponding to an interlace image within a field, thereby generating a progressive image. The intra-field interpolating section 361-2 interpolates an image of the estimated value Est2(n, t) corresponding to an interlace image within a field, thereby generating a progressive image.

The corrected value generating section 362 mixes the two estimated values Est1(n, t) and Est2(n, t), corresponding to the generated progressive image, according to the values of the two pieces of trust information Trst1(n, t−1) and Trst2(n, t−1), thus generating a corrected value. In this way, the estimated value Est(n, t) and the output pixel data Out(n, t) are outputted from this corrected value generating section 362.

The trust information calculating section 363-1 calculates the trust information Trst1(n, t), based on the estimated value Est1(n, t) and the pixel data IB(n, t). The trust information calculating section 363-2 calculates the trust information Trst2(n, t), based on the estimated value Est2(n, t) and the pixel data IB(n, t+1).

The trust information combining section 364 combines pieces of trust information, based on the value of the trust information Trst1(n, t) outputted from the trust information calculating section 363-1 and the value of the trust information Trst2(n, t) outputted from the trust information calculating section 363-2. In this way, the trust information Trst(n, t) in a processing pixel is calculated and outputted.

As described above, in the present modification, the corrected value calculating section and the IP converting section are integrated in the image pick-up blur suppressing section 3C, making it possible to simplify the whole structure of the display unit.

### Other Modifications

The present invention has been described above by way of embodiments and their modifications. However, the present invention is not limited to these embodiments, etc. but may be varied in many different ways.

For example, although the description of the embodiments, etc. above has been directed to the case of using the motion vector mv as an example of the characteristic value representing the characteristics of an image pick-up blur, other characteristic values may be used. More specifically, for example, a shutter speed of the image pick-up device may be used as the characteristic value. For instance, when a shutter opening time is 50%, it is appropriate to use 50% of the value of the motion vector mv as the characteristic value.

Further, in the image pick-up blur suppression in the first embodiment and its modifications described above, there may be a possibility that noise is emphasized in some cases. Thus, in order to suppress the possible detrimental effect, in the corrected value calculating section, it is desirable to perform gain control of the correction amount by the function of a differential signal amplitude with respect to a delayed pixel position of an input signal (for example, mv/2 delay), or to arrange various filters in an output section of the corrected value. As such filters, a ε filter is effective, for example. Likewise, in the image pick-up blur suppression in the second embodiment and its modifications described above, there may be a possibility that noise is emphasized in some cases. Thus, in order to suppress the possible detrimental effect, in the corrected value calculating section, it is desirable to perform gain control of the correction amount by the function of a frame differential signal amplitude of an input signal, or to arrange various filters in an output section of the corrected value. As such filters, a ε filter is effective, for example.

Moreover, in the model of the image pick-up blur and the calculation of the correction amount described in the embodiments, etc. above, the input video signal Din is data that has been subjected to a γ processing on the image pick-up device side (camera γ). On the other hand, the formula (1) serving as a model formula of the image pick-up blur is a video signal that is not subjected to a γ processing. Therefore, it is desirable to subject the video signal D1 to an inverse γ processing of the camera γ at the time of calculating the estimated value, and subject the same to a camera γ processing at the time of outputting the corrected value.

In addition, the image pick-up blur suppressing section described in the embodiments, etc. above may be used alone or in combination with other blocks, which are not shown (other image processing sections performing a predetermined image processing).

Moreover, in the high frame rate conversion executed in the embodiments, etc. described above, any combination of the first frame rate (frame frequency) of the input video signal and the second frame rate (frame frequency) of the output video signal may be adopted without any particular limitation. More specifically, for example, the first frame rate of the input video signal may be 60 (or 30) Hz, and the second frame rate of the output video signal may be 120 Hz. For example, the first frame rate of the input video signal may be 60 (or 30) Hz, and the second frame rate of the output video signal may be 240 Hz. For example, the first frame rate of the input video signal may be 50 Hz compatible with the PAL (Phase Alternation by Line) system, and the second frame rate of the output video signal may be 100 Hz or 200 Hz. For example, the first frame rate of the input video signal may be 48 Hz compatible with the telecine process, and the second frame rate of the output video signal may be a predetermined frequency equal to or higher than 48 Hz.

Additionally, the video signal processing unit of the present invention is applicable not only to the display unit described in the embodiments, etc. above but also devices other than the display unit (for example, a video signal recording device, a video signal recording/reproducing device or the like).

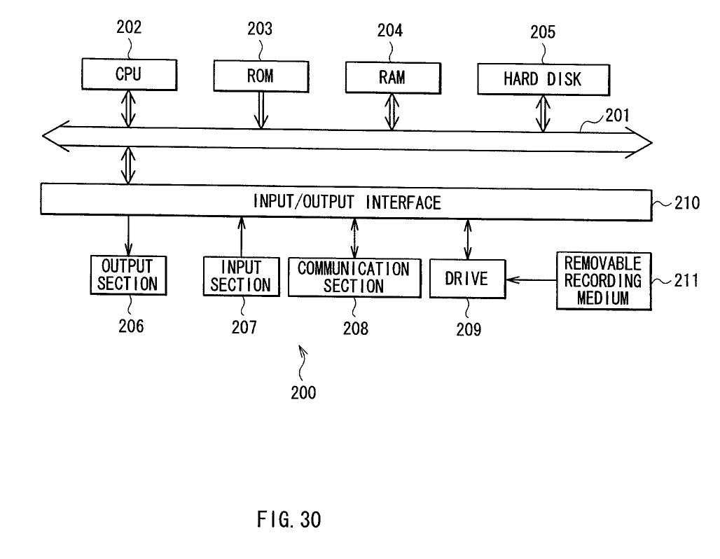

Furthermore, a series of processings described in the embodiments, etc. above may be executed by hardware or software. When the series of processings is executed by software, a program constituting this software is installed onto a general-purpose computer or the like. FIG. 30 is an exemplary structure of an embodiment of the computer onto which the program executing this series of processings is to be installed. Such a program may be recorded in advance in a hard disk 205 or a ROM 203 serving as a recording medium that is included in a computer 200. Alternatively, the program may be temporarily or permanently stored (recorded) in a removable recording medium 211. The removable recording medium 211 may be, for example, a flexible disk, a CD-ROM (Compact Disc Read Only Memory), an MO (Magneto Optical) disk, a DVD (Digital Versatile Disc), a magnetic disk, a semiconductor memory or the like. Such a removable recoding medium 211 may be provided as a so-called package software. Incidentally, the program may be not only installed from the removable recording medium 211 described above onto the computer but also transferred by radio waves from a download site via an artificial satellite for a digital satellite broadcasting to the computer or transferred by cables from such a download site via a network such as a LAN (Local Area Network) or the internet to the computer. Then, the computer may receive the program that is transferred in this way by a communication section 208 and install it onto the built-in hard disk 205.

Also, this computer 200 includes a CPU 202. This CPU 202 is connected with an input/output interface 210 via a bus 201. When a user operates an input section 207 constituted by a keyboard, a mouse, a microphone, etc. via the input/output interface 210, thereby inputting a command, the CPU 202 executes the program stored in the ROM 203 accordingly. Alternatively, the CPU 202 loads the program stored in the hard disk 205, the program that is transferred from the satellite or the network, received by the communication section 208 and installed onto the hard disk 205 or the program that is read out from the removable recording medium 211 inserted to a drive 209 and installed onto the hard disk 205 on a RAM (Random Access Memory) 204, and executes this program. In this way, the CPU 202 carries out a processing following the above-described flowchart or a processing performed by the structure of the above-described block diagram. Then, the CPU 202 outputs the processing result from an output section 206 constituted by an LCD, a speaker or the like via, for example, the input/output interface 210 or transmits the processing result from the communication section 208, or further stores the result in the hard disk 205, as necessary.

The present application contains subject matter related to that disclosed in Japanese Priority Patent Application JP 2009-117838 filed in the Japan Patent Office on May 14, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A video signal processing unit comprising:
a detecting section detecting, in each unit period, a characteristic value from an input video signal obtained by an image pick-up operation with an image pick-up device, the characteristic value showing a characteristic of image pick-up blur occurring in the image pick-up operation; and
a correcting section making a sequential correction, in each unit period, for pixel values of an input video image formed of the input video signal with use of the characteristic value, thereby suppressing the image pick-up blur in the input video signal, to generate an output video signal,
wherein the correcting section makes a correction to a target pixel value in the input video image within a current unit period by utilizing a correction result of a corrected pixel in the input video image within the current unit period.

2. The video signal processing unit according to claim 1, wherein
the correcting section determines a corrected pixel value of the target pixel with use of the characteristic value, the correction result of the corrected pixel and a pixel differentiation value, the corrected pixel being located away from the target pixel by the characteristic value in the input video image within the current unit period, and the pixel differentiation value being obtained through differentiating a target pixel value along a progressing direction of the sequential correction.

3. The video signal processing unit according to claim 2, wherein
the correcting section controls a correction level for the target pixel with use of trust information corresponding to a difference value between a corrected pixel value of the corrected pixel and an original pixel value of the corrected pixel.

4. The video signal processing unit according to claim 3, wherein
the correcting section ultimately determines the trust information by mixing pieces of trust information obtained for a plurality of corrected pixels, respectively.

5. The video signal processing unit according to claims 1, wherein
the correcting section obtains a plurality of correction results for a plurality of corrected pixels, respectively, and then mixes a plurality of corrected pixel values obtained with use of the plurality of correction results, respectively, thereby ultimately determining the corrected pixel value of the target pixel.

6. The video signal processing unit according to claim 5, wherein
the correcting section mixes the plurality of the corrected pixel values, according to a ratio of values of trust information which corresponds to a difference value between the corrected pixel value of the corrected pixel and an original pixel value of the corrected pixel.

7. The video signal processing unit according to claim 1, wherein
the characteristic value is a motion vector.

8. The video signal processing unit according to claim 1, wherein
the predetermined unit period is a period corresponding to one motion picture frame.

9. A display unit comprising:
a detecting section detecting, in each unit period, a characteristic value from an input video signal obtained by an image pick-up operation with an image pick-up device, the characteristic value showing a characteristic of image pick-up blur occurring in the image pick-up operation;
a correcting section making a sequential correction, in each unit period, for pixel values of an input video image formed of the input video signal with use of the characteristic value, thereby suppressing the image pick-up blur in the input video signal, to generate an output video signal; and
a display section displaying a video image based on the output video signal,
wherein the correcting section makes a correction to a target pixel value in the input video image within a current unit period by utilizing a correction result of a corrected pixel in the input video image within the current unit period.
